(19) United States
(12) Patent Application Publication
(10) Pub. No.: US 2015/0372952 A1
(43) Pub. Date: Dec. 24, 2015

(54) METHOD AND SYSTEM FOR ENHANCED CONTENT MESSAGING

(71) Applicant: VONAGE NETWORK LLC, Holmdel, NJ (US)

(72) Inventors: Marc Lefar, Holmdel, NJ (US); Jaya Meghani, Old Bridge, NJ (US); Nehar Arora, Old Bridge, NJ (US); Chen Arazi, Morganville, NJ (US); Ted Woodbery, Seattle, WA (US)

(21) Appl. No.: 14/498,190

(22) Filed: Sep. 26, 2014

Related U.S. Application Data
(60) Provisional application No. 62/013,842, filed on Jun. 18, 2014.

(51) Int. Cl. H04L 12/58

(52) U.S. Cl. CPC H04L 51/10; H04L 51/046

(57) ABSTRACT

Methods and system for integrating a media file within a text message on a user device are provided herein. In some embodiment, a method for integrating a media file within a text message may include sending a request to determine whether one or more text message terms included in a text message matches a predetermined list of terms, wherein each term in the predetermined list is associated with at least one media file, and receiving an indication of a match between the one or more text message terms and at least one term in the predetermined list, and tagging each of the matched text message terms with the at least one media file associated with the corresponding matched term in the predetermined list.

### BACKGROUND

1. Field

Embodiments consistent with the present invention generally relate to a method and system for enhanced content messaging.

2. Description of the Related Art

Many communications systems rely on the ease and convenience of sending and receiving messages via text (e.g., email, chat rooms, social media system updates, and the like). Message based communications substitute real-time human interaction with a series of text exchanges using short message service (SMS) and/or multimedia message service (MMS), commonly referred to as “text messaging”. Text messaging enables fast and succinct visual messaging between mobile phones, tablets, and computers that does not require speaking, listening, or real-time presence of users.

However, text based messaging effectively limits communication to almost exclusively receiving and sending of a visual stimulus. In recent developments, media (e.g., video, audio, and the like) may be sent as separate attachments. However, such communications lack a convenience and unity that is desirable to quickly and effectively integrate visual and audio communication for messaging.

Accordingly, there is a need for a method and system for enhanced content messaging that integrates visual text and audio.

### SUMMARY

Methods and system for integrating a media file within a text message on a user device are provided herein. In some embodiment, a method for integrating a media file within a text message may include sending a request to determine whether one or more text message terms included in a text message matches a predetermined list of terms, wherein each term in the predetermined list is associated with at least one media file, and receiving an indication of a match between the one or more text message terms and at least one term in the predetermined list, and tagging each of the matched text message terms with the at least one media file associated with the corresponding matched term in the predetermined list.

In some embodiments, a method for presentation of media files for integration into a text message may include storing a plurality of text message terms previously selected for media file tagging and a corresponding plurality of media files, prioritizing a media file of the plurality of media files for association with at least one term of the plurality of text message terms based on a frequency of previous selections of the media file to tag the at least one term of the plurality of text message terms, receiving a request from a user device to compare an entered text message term to the plurality of text message terms, and presenting to the user device, at least one prioritized media file suggestion for tagging to entered text message term.

In some embodiments, a system for integrating a media file within a text message may include a content enhancement interface configured to receive one or more text message terms generated in a text message on a user device, send a request to determine whether each of the text message terms matches a term in a predetermined list of media term, wherein each media term in the predetermined list is associated with at least one media file, receive an indication of a match between the one or more text message terms and at least one media term in the predetermined list, and tag each of the matched text message terms with the at least one media file associated with the corresponding matched term in the predetermined list.

In some embodiments, a system for presentation of media files for integration into a text message may include a suggestion module configured to store a plurality of text message terms previously selected for media file tagging and a corresponding plurality of media files, prioritize a media file of the plurality of media files for association with at least one term of the plurality of text message terms based on a frequency of previous selections of the media file to tag the at least one term of the plurality of text message terms, receive a request from a user device to compare an entered text message term to the plurality of text message terms, and present to the user device, at least one prioritized media file suggestion for tagging to the selected one or more text message terms.

Other and further embodiments of the present invention are described below.

### BRIEF DESCRIPTION OF THE DRAWINGS

Embodiments of the present disclosure, briefly summarized above and discussed in greater detail below, can be understood by reference to the illustrative embodiments of the disclosure depicted in the appended drawings. It is to be noted, however, that the appended drawings illustrate only typical embodiments of this disclosure and are therefore not to be considered limiting of its scope, for the disclosure may admit to other equally effective embodiments.

FIG. 1A is a block diagram of a communication system including a plurality of user devices in accordance with one or more exemplary embodiments of the invention;

FIG. 1B is a block diagram of an Internet based communication system including a plurality of user devices in accordance with one or more exemplary embodiments of the invention;

FIG. 2 is a block diagram of an exemplary user device in the communication system of FIG. 1 in accordance with one or more exemplary embodiments of the invention;

FIG. 3 is a block diagram of the content enhancement server in the communication system of FIG. 1 in accordance with one or more exemplary embodiments of the invention;

FIG. 4 is a flow diagram of a method for integrating a media file into a text message in accordance with one or more embodiments of the invention;

FIG. 5 is a flow diagram of a method for presentation of media files for integration into a text message in accordance with one or more embodiments of the invention;

FIG. 6 is a depiction of a computer system that can be utilized in various embodiments of the present invention;

FIG. 7 is an exemplary graphical user interface (GUI) for integrating a media file into a text message in accordance with one or more embodiments of the invention; and

FIGS. 8A and 8B are exemplary graphical user interfaces (GUIs) for receiving an integrated media file into a text message in accordance with one or more embodiments of the invention.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

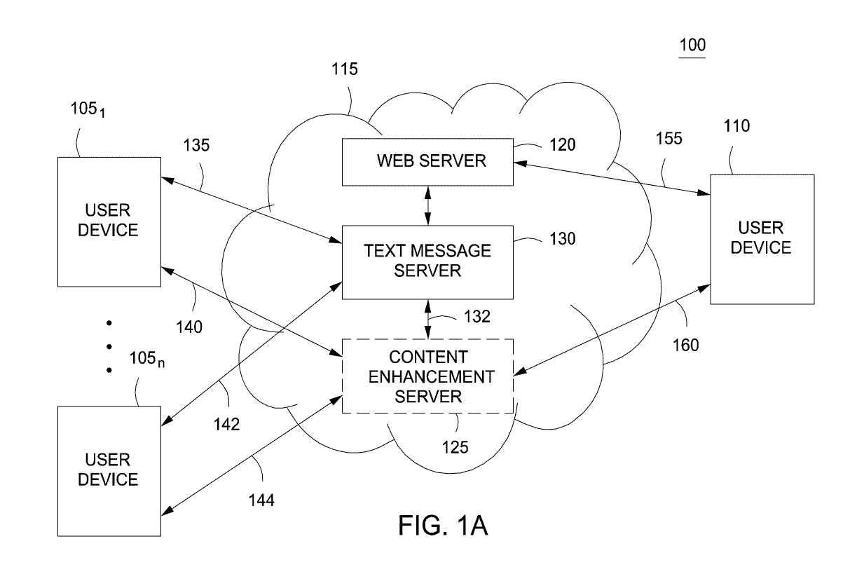

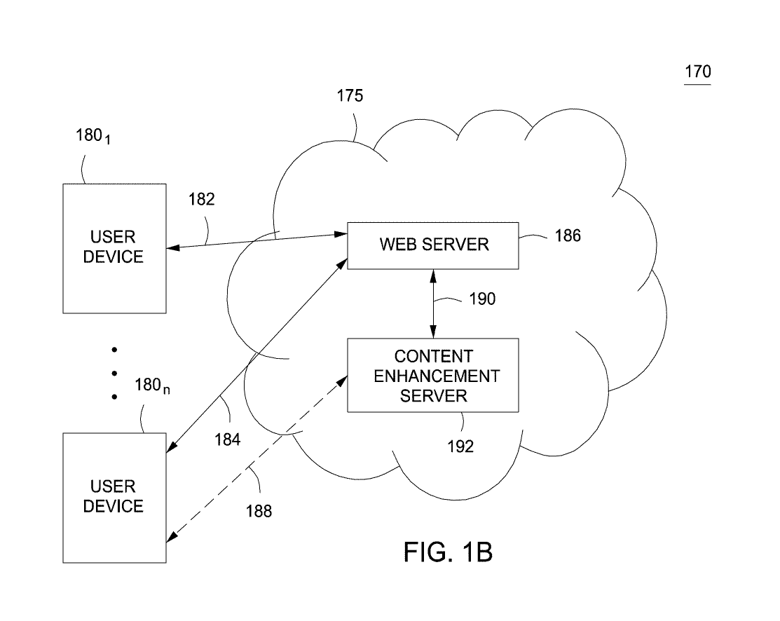

Embodiments of the present invention are directed to methods, apparatus, and systems for integrating media files, including audio/video or audio/video file information, into text based messages. The embodiments discussed herein may include devices engaging in mobile communications. Non-limiting forms of mobile communications include MMS and SMS text messaging using MM7 or short message service centers (SMSC) for routing messages and audio content discussed with respect to FIG. 1A below. Another form of mobile communications is text messaging delivered via the Internet through a shared application between two mobile devices based on Internet Protocols (IP) discussed with respect to FIG. 1B below. However, one of ordinary skill in the art would understand other text based communications such as chat programs, email, and the like may be used with embodiments of the present invention.

In embodiments described herein, a portion of a text message (e.g., a term or phrase) may be linked or tagged with an argument that specifies the location of a file, e.g., a media file such as an audio file. In some embodiments, text message objects (e.g., terms in a text message) may be marked, highlighted, or otherwise tagged and associated with a file (e.g., a media file). In some embodiments, the object is modified to become selectable, and may point or otherwise link to a media file within a graphical user interface. Pointing to a media file, such as an audio or video file, may be facilitated using metadata and supporting information to signify certain text in a text message is linked to a media file. In some embodiments, the media file is played when a recipient accesses or otherwise views the text message. In other embodiments, the media file is played when the tagged text is selected within the text message. As will be discussed further below, terms in a text message that are “tagged” with an media file are visually distinguished from untagged terms on sender and recipient devices.

In some embodiments, at least a portion of the text message may be transmitted as data packets over an IP network, via wireless local area network (WLAN) based on the Institute of Electrical and Electronics Engineers' (IEEE) 802.11x standards, for example, rather than employing traditional mobile phone mobile communication standardized technologies (e.g., 2G, 3G, and the like).

FIG. 1A is a block diagram of a communication system 100 including a plurality of user devices in accordance with one or more exemplary embodiments of the invention. The system 100 comprises a plurality of user devices 105₁ . . . 105ₙ, collectively referred to as user devices 105, and a network 115.

The network 115 includes a text message server 130 and a content enhancement server 125. In some embodiments, the network 115 includes a web server 120 for communicating with user devices (e.g., user device 110) that are unable to otherwise access the text message server 130 and communicate with user devices 105.

The text message server 130 facilitates the exchange of text messages between user devices 105 and 110. In some embodiments, the text message server 130 may communicate with the content enhancement server 125 to retrieve statistical usage data with regard to previous selections used in the tagging of audio files. Although described below in terms of audio and audio files, embodiments of the present invention may be used with media files or objects such as video files (e.g., videos, movie clips, etc.) as well. In some embodiments, the text message server 130 is located within a telecommunication server provider network. In other embodiments, the text message server 130 is a representation of multiple message servers across multiple telecommunication server provider networks that facilitate inter-network text message communications.

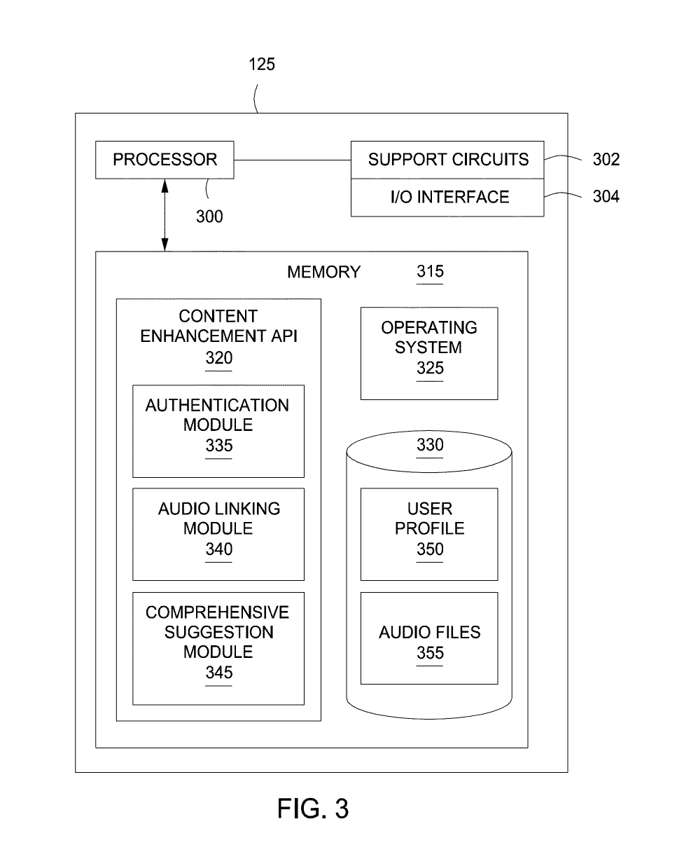

The content enhancement server 125 is a computer that generates audio terms, clips, and stores in memory, audio files and associated extensions for retrieving audio files that are linked to tag corresponding term(s) in text messages. Alternative embodiments include where the audio file is user generated content, such as by recording the voice of a user or local sound via the microphone on the user devices 105. As will be discussed further below with respect to FIG. 3, in additional embodiments, the content enhancement server 125 determines suggestions for the user devices 105 and 110 as to recommendations of audio files for a corresponding term by applying weighting values. Suggestions may be determined by user preferences as well as heuristics regarding previously selected audio files for tagging a term. In addition, the content enhancement server 125 may be communicatively coupled to the web server 120 to monitor news data and additional social trends. For example, the content enhancement server 125 may determine a new movie or popular song is generating interest across multiple social media networks. Continuing this example, the content enhancement server 125 would subsequently adjust weighting to rank suggestions for the movie, song, or news clip as possible matches for a term.

As shown in FIG. 1A, the text message server 130 may communicate with user device 105₁ over text message communication link 135 to send/receive text messages. The text messages sent via link 135 may include text that comprises at least one corresponding term tagged with an audio file. In some embodiments, audio files or links to audio files are transferred between the text message server 130 and the content enhancement server 125 as shown over communication link 132. In some embodiments, the audio files may be sent as part of an MMS message to participants in a text communication over communications link 142.

In other embodiments, recipients receive tagging information in the form of metadata establishing a link to a corresponding audio file stored on the content enhancement server 125. In some embodiments, the content enhancement server 125 may communicate with user devices 105 (e.g., over communication link 140) to provide tagging information and/or streaming audio data. Alternatively, an audio file may be downloaded to the cache of the user device 105₁ to preview the audio file prior to tagging text. Similarly, the audio file is sent along with the text messages to all participants for playback from the content enhancement server as shown by communication links 144 and 160.

Further embodiments include user device 110 coupled to the network 115 via an Internet connection to the web server 120 and shown as communication link 155. In such an embodiment, the web server 120 coordinates communication with other networks (e.g., a cellular network not shown) to communicate with the text message server 130 and content enhancement server 125. Upon receiving a text message that includes terms tagged with an audio file, the audio file may be downloaded or streamed from the content enhancement server 125 as depicted by communication link 160.

FIG. 1B is a block diagram of an Internet based communication system 170 including a plurality of user devices in accordance with one or more exemplary embodiments of the invention. The system 170 is an alternative embodiment of system 100 that relies on an Internet based communication between applications stored on user devices 180. The system 170 comprises a plurality of user devices 180₁ . . . 180ₙ, collectively referred to as user devices 180, a web server 186, a content enhancement server 192, and a network 175. The web server 186 and the content enhancement server 192 are communicatively coupled as shown with communications link 190. In some embodiments, the content enhancement server 192 and web server 186 are integrated together as a single server.

The network 175 is a combination of cellular and Internet based connections utilized to couple user devices 180 to the web server 186 (shown as communication links 182 and 184). In a first mode of operation, the web server 186 securely exchanges communications between user devices 180. In a second mode of operation, the content enhancement server 192 processes requests by user devices 180 to attach and retrieve audio files to text messages. In operation, a user device authenticates credentials of a user on the content enhancement server. The content enhancement server then presents audio file options as well as suggestions based on heuristics and account data for each user. Once selected, audio files are tagged to terms in a text message either by attaching a web-based link or transmitting an audio file to other selected recipient user devices 180_{N-1}. In embodiments where tagging is performed using a web-based link, the target audio file may be streamed from the content enhancement server 192 (shown as communications link 188) or downloaded to the recipient user devices 180_{N-1}.

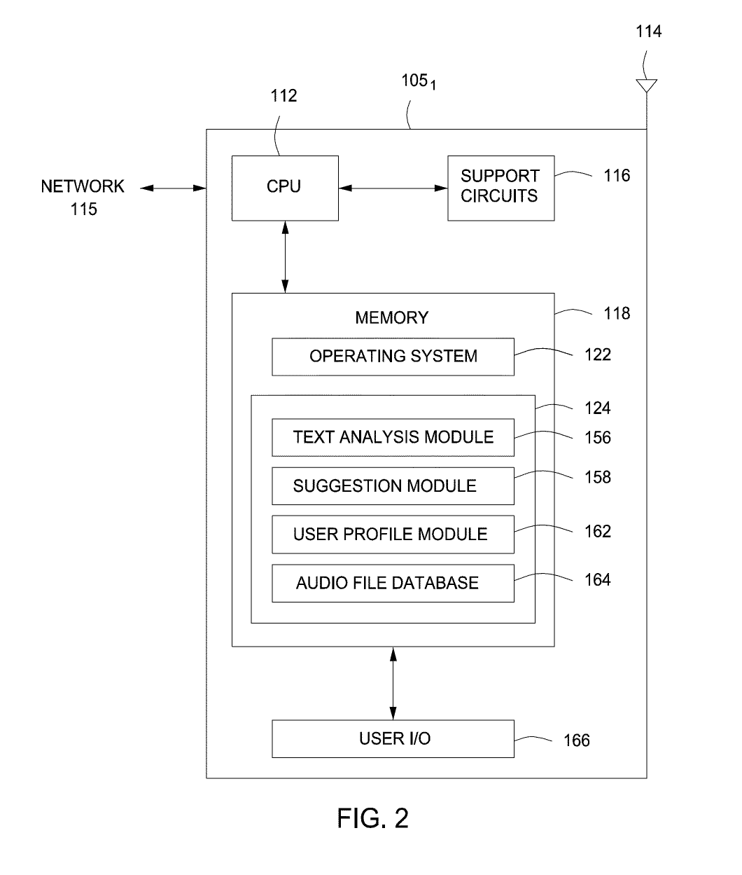

FIG. 2 is a block diagram of an exemplary user device 105₁ in the communication system 100 of FIG. 1 in accordance with one or more exemplary embodiments of the invention. Similarly, the block diagram of user devices 105 discloses features of user device 110 and that of user devices 180 in system 170.

The user device 105₁ comprises an antenna 114, a CPU 112, support circuits 116, memory 118, and user input/output interface 166. The CPU 112 may comprise one or more commercially available microprocessors or microcontrollers that facilitate data processing and storage. The various support circuits 116 facilitate the operation of the CPU 112 and include one or more clock circuits, power supplies, cache, input/output circuits, and the like. The memory 118 comprises at least one of Read Only Memory (ROM), Random Access Memory (RAM), disk drive storage, optical storage, removable storage and/or the like.

The support circuits 116 include circuits for interfacing the CPU 112 and memory 118 with the antenna 114 and I/O interface 166. The I/O interface 166 may include a speaker, microphone, additional camera optics, touch screen, buttons and the like for a user to send and receive text messages.

The memory 118 stores an operating system 122, and an installed enhanced text messaging application 124. In some embodiments, the installed enhanced text messaging application 124 is a telecommunications application. The enhanced text messaging application 124 comprises a text analysis module 156, suggestion module 158, user profile module 162, and audio file database 164. The enhanced text messaging application 124 coordinates communication among these modules to generate and communicate data for text messages and text messages integrated with audio files. In some embodiments, the text analysis module 156, suggestion module 158, user profile module 162, and/or audio file database 164 may be located in the content enhancement server 125. Alternatively, the content enhancement server 125 may provide supplemental processing of text tagging and audio suggestion to the modules as well as store audio files.

The operating system (OS) 122 generally manages various computer resources (e.g., network resources, file processors, and/or the like). The operating system 122 is configured to execute operations on one or more hardware and/or software modules, such as Network Interface Cards (NICs), hard disks, virtualization layers, firewalls and/or the like. Examples of the operating system 122 may include, but are not limited to, LINUX, CITRIX, MAC OSX, BSD, UNIX, MICROSOFT WINDOWS, WINDOWS MOBILE, 10S, ANDROID and the like.

The operating system 122 controls the interoperability of the support circuits 116, CPU 112, memory 118, and the I/O interface 166. The operating system 122 includes instructions such as for a graphical user interface (GUI) and coordinates data from the enhanced text messaging application 124 and user I/O interface 166 to communicate with text messages.

The text analysis module 156 examines the terms in a text message for potential tagging to an audio file. As used herein, a term may include one or more words (i.e., a phrase). In some embodiments, the terms are automatically detected and in other embodiments, the terms are manually selected by a user. The automatic detection may occur after a full message is entered or in real-time using prediction algorithms as text is entered into the user device 105₁. In the automatic detection embodiment, the text analysis module 156 parses characters, terms, and phrases from text messages and performs a comparison against a predetermined audio list. The predetermined audio list is a compilation of words and phrases corresponding to song lyrics, news clips, movie quotes, famous quotes, emotions, sentiments, events, and the like. The text analysis module 156 determines potential matches to the audio list and transmits the results to the suggestion module 158. In embodiments where the text is manually selected by the user, the suggestion module 158 prompts the user to select a corresponding audio file to tag the text as well as provides recommendations of audio files.

The suggestion module 158 receives selection choices from the GUI and also provides recommendations to the user of possible audio files that are relevant for any text determined to match an audio term. Relevancy may be determined by weighting audio terms for each matched text. The adjustments of the weighting may be by the popularity of an audio file, such that suggestions are based on the previous or contemporaneous selections made by other users for the same matched text. The highest weighting may be given to those selections previously made by the user on the user device 105₁, in anticipation of a desire for repetitious tagging by a single user. In some embodiments, the suggestion module 158 also applies folksonomy algorithms for following trending social media topics and news to determine suggestions of audio clips of songs, movies, or quotes. Folksonomy algorithms allow organization and indexing of audio clips and songs to be presented in a manner of popularity for a group during a specified time period. For example, folksonomy algorithms would sort audio clips such that a new popular release album is the first suggestion.

The suggestion module 158 also considers preferences stored in the user profile module 162. The user profile module 162 generates and stores past audio selections made by users as well as user preferences. For example, if a user has indicated a preference for 1980s popular music, a text match of “criminal” may propose tagging an audio clip from the song “Smooth Criminal” by Michael Jackson. In another example, colloquialisms may be predetermined such that when a user enters “I hope you understand”, the suggestion module 158 may suggest a sound bite from of President Obama saying his ubiquitous phrase “let me be clear” or “make no mistake”. In addition, if a user profile module 162 indicates an audio file has been previously selected for a matched text, this suggestion may be assigned a higher weight and priority over all other suggestions. In some embodiments, the suggestion module 158 may accentuate terms that are tagged with an audio clip.

The audio file database 164 may store links to audio files as well as individual audio files. The audio files may be downloaded to the user device 105₁ for previewing on the user device 105₁ or streamed across the network 115 from a remote server (e.g., the content enhancement server 125).

Upon selection by the user, the matched text in the text message is tagged with the audio file. The audio file may be stored in the audio file database 164. In other embodiments, the tagged text may include a link across the network 115 to the content enhancement server that stores the audio files. The text message, including any audio tags, is processed for transmission as a text message by the enhanced text messaging application 124 and user I/O 166 to the text message server 130 in system 100 or web server 186 in system 170. In some embodiments, the portions of a text message that are tagged will be substituted with highlighted text, symbols, and the like to call attention to the recipient that the text has an associated audio clip.

Upon receiving the text message, the audio file may be played automatically upon viewing the message on the recipient user device (e.g., 105_{N}) through an audio player on the user device. In other embodiments, the recipient must select the tagged text to initiate playback of the audio file. The audio file played is streamed from a remote server (e.g., content enhancement server 125). Alternatively, the audio file is downloaded with the text message or viewing of the text message on the recipient user device (e.g., 105_{N}).

FIG. 3 is a block diagram of the content enhancement server 125 in the communication system 100 of FIG. 1 in accordance with one or more exemplary embodiments of the invention. The content enhancement server 125 disclosed herein may also store the modules of the enhanced text messaging application 124. Alternative embodiments of the content enhancement server 125 thus include supplementary processing features to the content enhanced text messaging application 124.

The content enhancement server 125 comprises a processor 300, support circuits 302, I/O interface 304, and memory 315. The processor 300 may comprise one or more commercially available microprocessors or microcontrollers that facilitate data processing and storage. The various support circuits 302 facilitate the operation of the processor 300 and include one or more clock circuits, power supplies, cache, input/output circuits, and the like. The memory 315 comprises at least one of Read Only Memory (ROM), Random Access Memory (RAM), disk drive storage, optical storage, removable storage and/or the like.

The memory 315 stores a content enhancement application programming interface (API) 320, operating system 325, and database 330. The operating system (OS) 3250 generally manages various computer resources (e.g., network resources, file processors, and/or the like). The operating system 330 is configured to execute operations on one or more hardware and/or software modules, such as Network Interface Cards (NICs), hard disks, virtualization layers, firewalls and/or the like. Examples of the operating system 325 may include, but are not limited to, LINUX, CITRIX, MAC OSX, BSD, UNIX, MICROSOFT WINDOWS, 10S, ANDROID and the like.

The database 330 stores user profiles 350 and audio files 355. Audio files 355 are in addition to any audio files stored on the user device 105 and 110. User profiles 350 store user tagging data such as: the tagged text, selected audio file, preview duration, playback duration, date tagged, sender address, recipient address, and the like.

The content enhancement API 320 comprises an authentication module 335, a comprehensive suggestion module 345, and an audio linking module 340. The authentication module 335 verifies a user device 105 seeking to connect to the content enhancement server 125 matches an existing user profile 350. In some embodiments, the authentication module 335 also securely facilitates communication of enhanced text messages (i.e., text messages with integrated audio files) between user devices 105 and the network (e.g., network 175).

Recipients of enhanced text messages that are non-members may be prompted to register and enter user data to create a new user profile with the content enhancement server 125. A registered user profile may store data of use preferences for both composing enhanced text messages and receiving enhanced text messages. For example, the suggestion module 158 may present to users a higher weight for songs of audio files based on the user profiles 350 of intended recipients. In this example, a composing user will be prompted with suggestions that are adjusted to audio preferences of the recipient.

The comprehensive suggestion module 345 is operative to provide further examination of criteria for recommending audio files for matched text. The comprehensive suggestion module 345 adjusts weighting of suggestions for matched text based on the criteria discussed above, as well as retrieving Internet data from the web server 120. Reviewing Internet data facilitates recommendations of audio files using parameters such as mood, movie preferences, and an analysis of a social media accounts. For example, the suggestion module may weight suggestions associated with a song that is currently trending, or otherwise being discussed, in social media platforms higher than other songs when determining a suggestion for a term or phrase that matches a lyric from the song and the matched text in the text message).

In addition, the comprehensive suggestion module 345 may access the Internet through the web server 120 to provide enhanced text message match recognition by context. For example, the comprehensive suggestion module 345 may access a search engine or other internet service to determine related, additional, or alternative words that are used in conjunction with, or in place of, the word/phrase being matched, in order to determine a recommendation of a media file (e.g., audio file) for tagging to the noun. Additional embodiments include context based algorithms to refine word matching.

In some embodiments, the comprehensive suggestion module 345 creates the audio files based on longer clips of audio files. For example, in songs, the comprehensive suggestion module 345 creates a sound clip of a repeated verse in a chorus. In audio files for television shows or movies, the comprehensive suggestion module 345 recalls notable quotes from Internet sources such as INTERNET MOVIE DATABASE (IMDB), celebrity fan sites, movie review websites, trending TWITTER feed quotes, and the like. The audio may be translated into text in order to be parsed and matched for the comprehensive suggestion module 345 to provide a corresponding suggestion.

The audio linking module 340 generates target metadata for locating audio files and associating the audio files with the terms desired to be tagged within a text message. The audio linking module 340 also updates the list of audio terms and adjusts weighting based on whether an audio file is selected for target metadata in the tagging of a term in the text message. Audio terms are provided based on the suggestion modules 158 and 345 as well as previous selections by users. The audio linking module 340 accentuates (e.g., highlights, underlines, bolds, italicizes, and the like) the term that is tagged in the text message. Thus, it becomes apparent specific terms in a text message are tagged with an associated audio file.

In some embodiments, the audio linking module 340 interprets arguments embedded in the text messages applied for tagging words with audio files. The audio linking module 340 associates calls to an audio file from either the recipient or sender user device. Subsequently, the audio linking module 340 either streams or transmits for download the corresponding stored audio files 355. In other embodiments, the audio file is linked and sent along with the text message using MMS or via the Internet.

In further embodiments, the comprehensive suggestion module 345 performs the text analysis functions of text analysis module 156 and suggestion module 158. In such an embodiment, the identifying, matching, and tagging (through the audio linking module 340) processing steps are executed from the user device 105. In this embodiment, the integration of audio files is generated on individual user devices 105 and the network (e.g., 175) is used to communicate the message and retrieve the audio files.

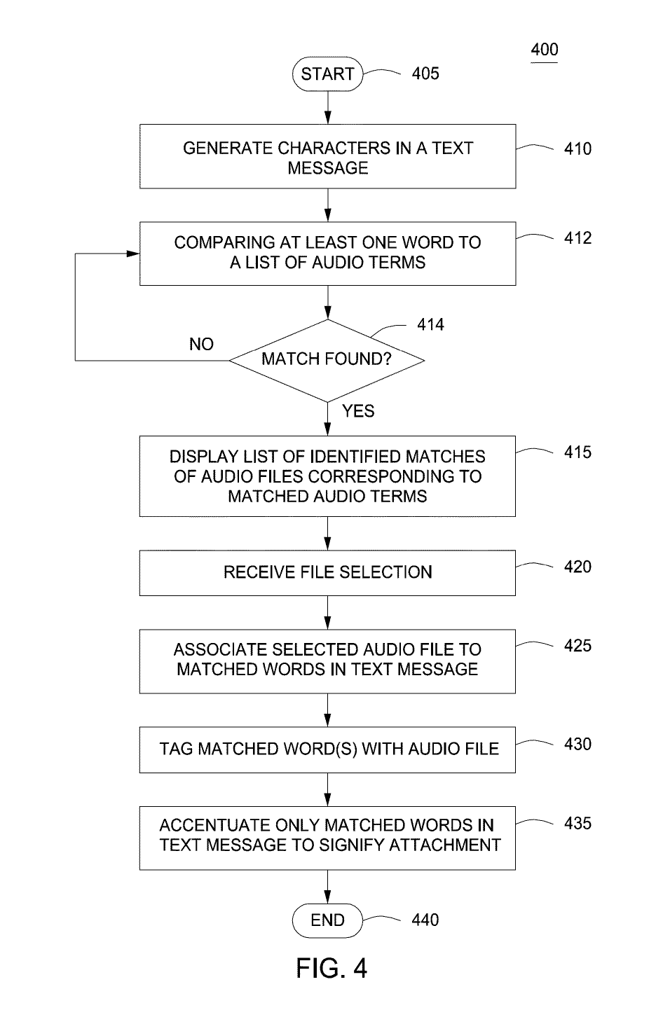

FIG. 4 is a flow diagram of a method 400 for integrating an audio file into a text message in accordance with one or more embodiments of the invention. The method 400 is implemented by the system 100 in the Figures described above. The method 400 will be described in view of exemplary user device 105_{N}, however similar embodiments include user device 110 to access the text message server 130 or web server 186.

The method 400 begins at step 405, and continues to step 410. At step 410, characters are generated on the user device 105_{N} through entry by a user in a GUI and a text message application (e.g., enhanced text messaging application 124).

Next, at step 412, the generated text is compared to a predetermined list of audio terms to find a match. The predetermined list includes a combination of dictionary terms, popular internet search terms, as well as terms translated to text from audio clips. In some embodiments, the predetermined list may be stored locally on the user device 105_{N}, while in other embodiments the predetermined list is stored on a remote server. In some embodiments, the comparison performed at 412 may include sending one or more requests including the text message terms entered in the text message to determine if a match exists. The request may be an API call, or other type of procedure call or message, requesting an indication of whether or not a match exists. In embodiments where the predetermined list is stored on a remote server, the request may be sent to the remote server. In some embodiments, the request is sent for each term, and/or for groups of terms, in real-time as the one or more text message terms are entered in the text message on the user device. In response to the request sent, an indication that the text message term matches a term in the predetermined list may be received.

At step 414, if no match is found, the method 400 reverts back to step 412. If however, a match is found (e.g., an indication that the text message term matches a term in the predetermined list is received), the method 400 proceeds to step 415.

At step 415, a list of identified audio files matching at least a portion of the terms in the text message is displayed on the user device 105_{N}. At step 420, a selection of an audio file to tag the terms is received. At step 425, the audio file is associated to the matching words in the text message.

At step 430, the matching words are tagged with the audio file. The text is tagged by integrating a call to a remote server for recalling the corresponding audio file. The method 400 then proceeds to step 435 where the matched words are replaced or modified to notify the recipient certain words in the text message have an accompanying audio file. The method 400 may accentuate only the matched words by underlining the words, highlighting the words, italicizing, bolding, or replacing the text with a symbol. The method 400 then ends at step 440.

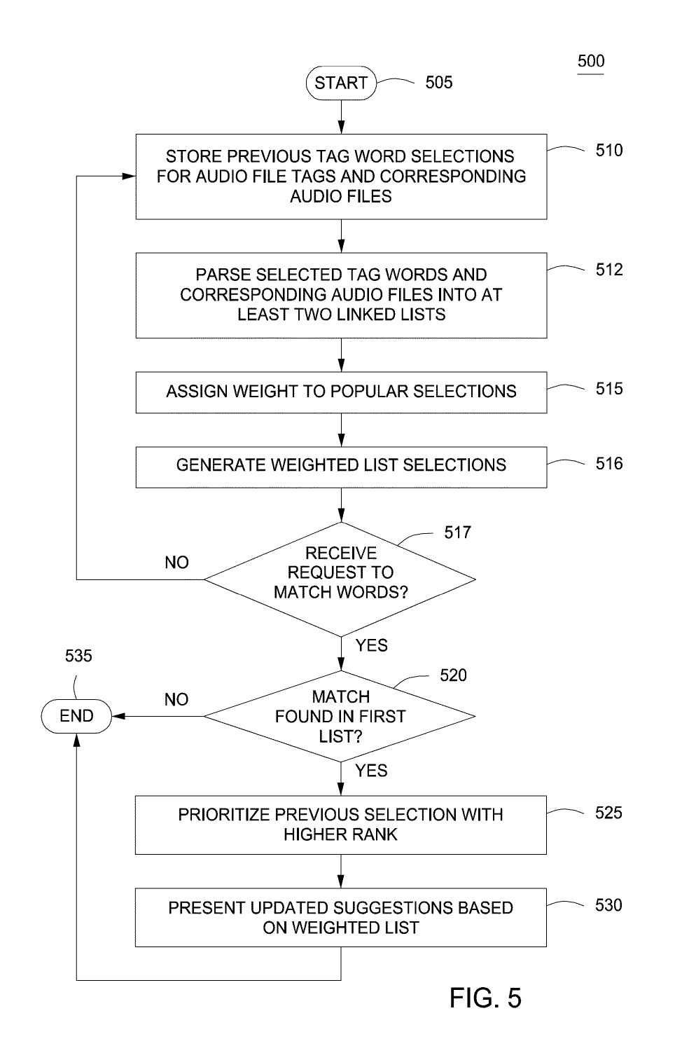

FIG. 5 is a flow diagram of a method 500 for presentation of audio files for integration into a text message in accordance with one or more embodiments of the invention. The method 500 is implemented by the system 100 or system 170 in the Figures described above. The method 500 will be described in view of exemplary user device 105_{N}, however similar embodiments include user device 110 to access the text message server 130 or web server 186.

The method 500 begins at step 505 and continues to step 510. At step 510, the previous tag words selected for tagging in a text message of all user devices 105 are stored in memory (e.g., database 330). At step 510, the corresponding audio files are also stored in database 330.

At step 512, tag words are parsed and stored in a first list. The corresponding audio files are parsed into a second list that is linked to the first list. In some embodiments, audio files are associated with media terms representing a suggestion of the audio file. Following the previous example, an audio clip from the song “Smooth Criminal” by Michael Jackson may be associated with the media term “criminal”. The media term may be extracted using a speech to text translation or manually associated to the audio file.

At step 515, the priority of audio files is established by assigning weights based on the popularity of previous selections used to tag a specific term with a given audio file. In other words, prioritization of audio files is based on the popularity of the selection of the audio file for previous tagging of terms in the text message.

At step 516, a weighted list of suggested selections is generated using the criteria discussed above. At step 517, the method 500 determines whether a request to compare words in a text message is received, and if not received, the method 500 returns to step 510. By reverting to step 510, the list of audio terms is accumulated as user devices 105 manually tag text with audio files and/or select those audio files suggested by the system 100. If a request to compare words in the two linked lists is received, the method 500 proceeds to step 520.

At step 520, the method 500 determines whether a match is found in the first list. If no match is found, the method 500 ends at step 535 since automated matching is unavailable if the word in the text message is not in the first list (i.e., pre-determined words for tagging). If a match is found, the method 500 proceeds to step 525.

At step 525, the method 500 prioritizes previous selections as suggestions with the highest weight and rank for the matched word. In other embodiments, prioritization may be based on social media popularity, folksonomy, user popularity interests stored in a user profile, and the like. Then at step 530, the updated suggestions based on the weighted list of audio terms (and corresponding audio files) are presented to the user device 105_{N}. The method 500 then ends at step 535.

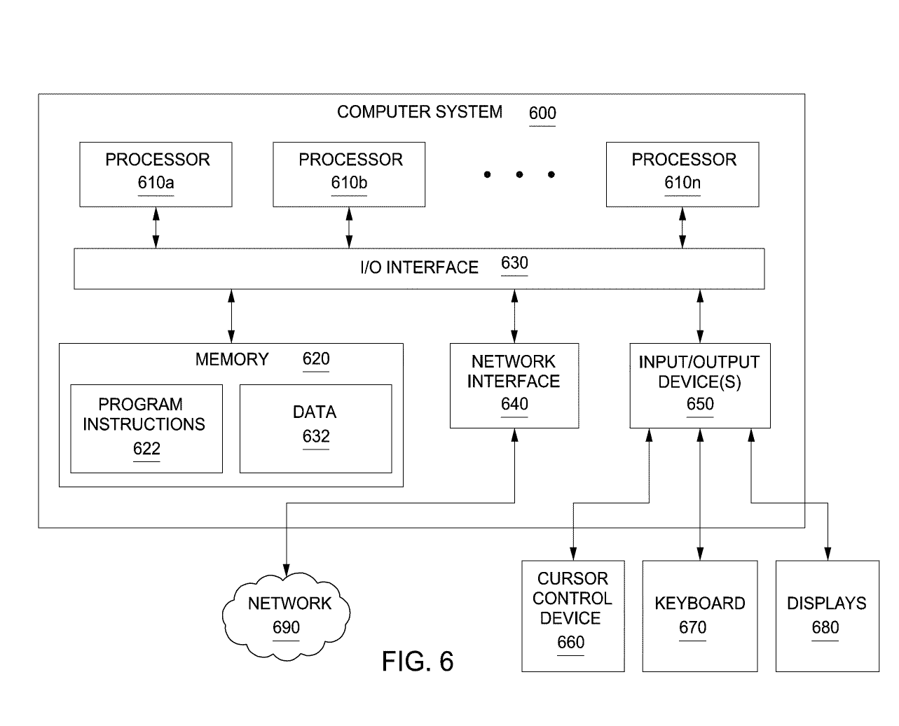

FIG. 6 is a depiction of a computer system 600 that can be utilized in various embodiments of the present invention. The computer system 600 includes substantially similar structure comprising servers or electronic devices in the aforementioned embodiments.

Various embodiments of methods and system authenticating users for communication sessions, as described herein, may be executed on one or more computer systems, which may interact with various other devices. One such computer system is computer system 600 illustrated by FIG. 6, which may in various embodiments implement any of the elements or functionality illustrated in FIGS. 1A-5. In various embodiments, computer system 600 may be configured to implement methods described above. The computer system 600 may be used to implement any other system, device, element, functionality or method of the above-described embodiments. In the illustrated embodiments, computer system 600 may be configured to implement methods 400, and 500 as processor-executable executable program instructions 622 (e.g., program instructions executable by processor(s) 610) in various embodiments.

In the illustrated embodiment, computer system 600 includes one or more processors 610a-610n coupled to a system memory 620 via an input/output (I/O) interface 630. Computer system 600 further includes a network interface 640 coupled to I/O interface 630, and one or more input/output devices 660, such as cursor control device 660, keyboard 670, and display(s) 680. In some embodiments, the keyboard 670 may be a touchscreen input device.

In various embodiments, any of the components may be utilized by the system to authenticate a user for enhanced content messaging as described above. In various embodiments, a user interface may be generated and displayed on display 680. In some cases, it is contemplated that embodiments may be implemented using a single instance of computer system 600, while in other embodiments multiple such systems, or multiple nodes making up computer system 600, may be configured to host different portions or instances of various embodiments. For example, in one embodiment some elements may be implemented via one or more nodes of computer system 600 that are distinct from those nodes implementing other elements. In another example, multiple nodes may implement computer system 600 in a distributed manner.

In different embodiments, computer system 600 may be any of various types of devices, including, but not limited to, personal computer systems, mainframe computer systems, handheld computers, workstations, network computers, application servers, storage devices, a peripheral devices such as a switch, modem, router, or in general any type of computing or electronic device.

In various embodiments, computer system 600 may be a uniprocessor system including one processor 610, or a multiprocessor system including several processors 610 (e.g., two, four, eight, or another suitable number). Processors 610 may be any suitable processor capable of executing instructions. For example, in various embodiments processors 610 may be general-purpose or embedded processors implementing any of a variety of instruction set architectures (ISAs). In multiprocessor systems, each of processors 610 may commonly, but not necessarily, implement the same ISA.

System memory 620 may be configured to store program instructions 622 and/or data 632 accessible by processor 610. In various embodiments, system memory 620 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 620. In other embodiments, program instructions and/or data may be received, sent or stored upon different types of computer-accessible media or on similar media separate from system memory 620 or computer system 600.

In one embodiment, I/O interface 630 may be configured to coordinate I/O traffic between processor 610, system memory 620, and any peripheral devices in the device, including network interface 640 or other peripheral interfaces, such as input/output devices 650. In some embodiments, I/O interface 630 may perform any necessary protocol, timing or other data transformations to convert data signals from one component (e.g., system memory 620) into a format suitable for use by another component (e.g., processor 610). In some embodiments, I/O interface 630 may include support for devices attached through various types of peripheral buses, such as a variant of the Peripheral Component Interconnect (PCI) bus standard or the Universal Serial Bus (USB) standard, for example. In some embodiments, the function of I/O interface 630 may be split into two or more separate components, such as a north bridge and a south bridge, for example. Also, in some embodiments some or all of the functionality of I/O interface 630, such as an interface to system memory 620, may be incorporated directly into processor 610.

Network interface 640 may be configured to allow data to be exchanged between computer system 600 and other devices attached to a network (e.g., network 690), such as one or more external systems or between nodes of computer system 600. In various embodiments, network 690 may include one or more networks including but not limited to Local Area Networks (LANs) (e.g., an Ethernet or corporate network), Wide Area Networks (WANs) (e.g., the Internet), wireless data networks, wireless local area networks (WLANs), cellular networks, some other electronic data network, or some combination thereof. In various embodiments, network interface 640 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 650 may, in some embodiments, include one or more display devices, keyboards, keypads, cameras, touchpads, touchscreens, scanning devices, voice or optical recognition devices, or any other devices suitable for entering or accessing data by one or more computer systems 600. Multiple input/output devices 650 may be present in computer system 600 or may be distributed on various nodes of computer system 600. In some embodiments, similar input/output devices may be separate from computer system 600 and may interact with one or more nodes of computer system 600 through a wired or wireless connection, such as over network interface 640.

In some embodiments, the illustrated computer system may implement any of the methods described above, such as the methods illustrated by the flowchart of FIGS. 4, and 5. In other embodiments, different elements and data may be included.

Those skilled in the art will appreciate that computer system 600 is merely illustrative and is not intended to limit the scope of embodiments. In particular, the computer system and devices may include any combination of hardware or software that can perform the indicated functions of various embodiments, including computers, network devices, Internet appliances, smartphones, tablets, PDAs, wireless phones, pagers, and the like. Computer system 600 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 600 may be transmitted to computer system 600 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

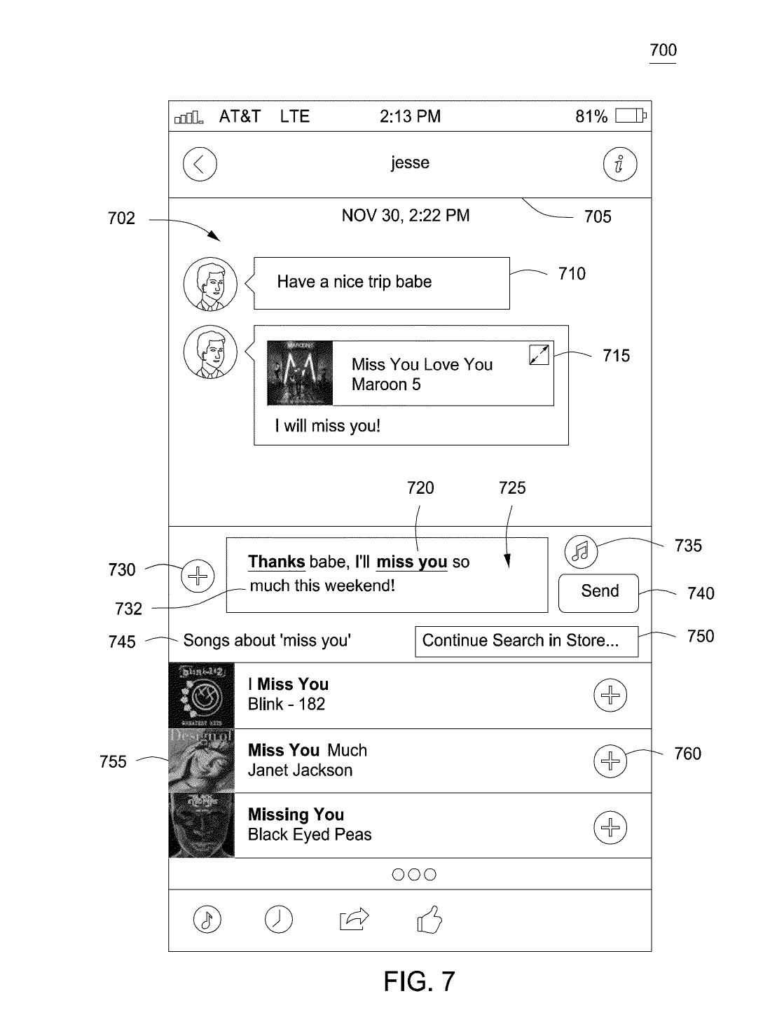

FIG. 7 is an exemplary graphical user interface (GUI) 700 for integrating an audio file into a text message in accordance with one or more embodiments of the invention. The GUI 700 depicts a communication from the perspective of a recipient 705 of a text message with an integrated audio file that is replying also with a text message integrated with an audio file. The GUI 700 comprises a participation identification area 702, text conversation area 705, respondent area 725, manual tagging button 730, automated tagging button 735, send button 740, recommended local audio files 745, and recommended remote audio files 750.

The conversation area 705 comprises a received text message 710 and a received text message integrated with an audio file 715. The manual button 730 initiates a function to prompt a user to manually select an audio file to tag to selected text or the entire text message.

The respondent area 725 comprises plain text 732 that includes tag text 720 to be used in tagging with audio files. The tag text 720 in this embodiment is accentuated by changing font color and underlining. The tag text 720 may be manually selected by the user or automatically detected as described above. The automated tagging button 735 initiates a function to examine the plain text 732 for tag text 720. The automated tagging may be turned on prior to plain text 732 entry for real-time examination as the plain text 732 is entered or after entry of a full message.

For tagging, the user is presented with media (e.g., song 755) and the ability to select the recommended song with a selection button 760 among recommended local audio files 745. In addition, the system 100 may suggest songs from the remote database 330 for recommended remote audio files 750.

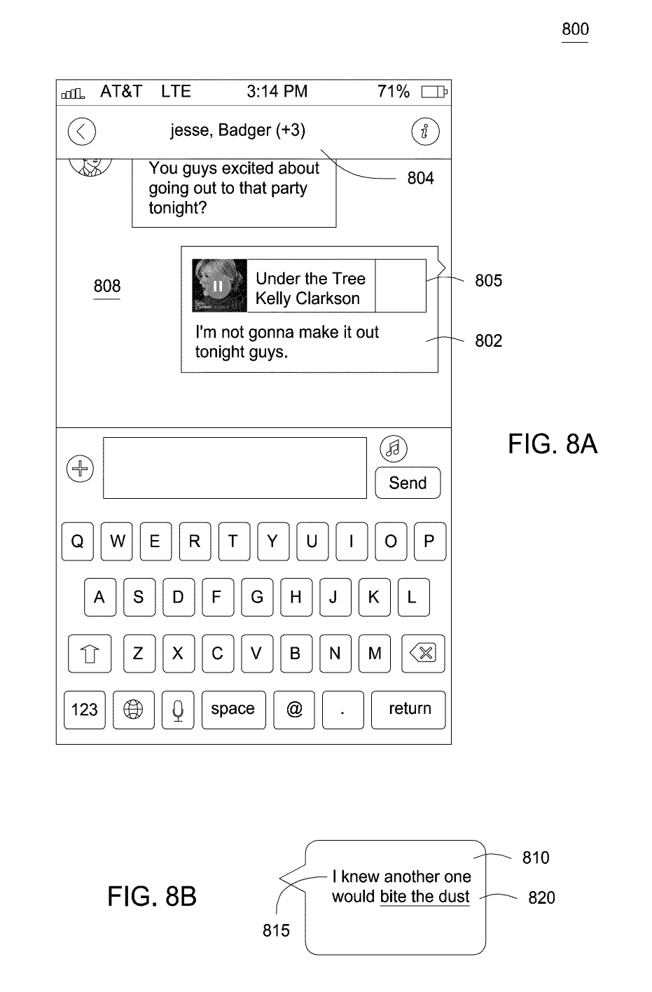

FIGS. 8A and 8B are exemplary graphical user interfaces (GUIs) 800 for receiving an integrated audio file into a text message in accordance with one or more embodiments of the invention. FIG. 8A depicts another exemplary GUI 800 with six participants 804 (e.g., five recipients and the current user view in GUI 800) using a conversation area 808. Any participant may playback an integrated audio file by selecting the file 805. The file 805 may include a background simulating a playback tracking bar. In some embodiments, the playback is automated upon viewing a message with the file 805.

FIG. 8B is an exemplary embodiment integrated text message 810. The integrated text message bubble includes plain text 815 (e.g., unmatched or untagged terms) and tagged text 820. As with FIG. 7, the tagged text 820 is accentuated to signify to all participants the portion of the text message has an accompanying audio file. By slightly modifying the text, in FIG. 8B, audio files can be integrated without disrupting the flow of reading in the conversation area 808 that would otherwise be crowded with audio file images and descriptors.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

What is claimed is:

1. A method for integrating a media file within a text message on a user device comprising:
sending a request to determine whether one or more text message terms included in a text message matches a predetermined list of terms, wherein each term in the predetermined list is associated with at least one media file;
receiving an indication of a match between at least one of the one or more text message terms and at least one term in the predetermined list; and
tagging each of the matched text message terms with the at least one media file associated with the corresponding matched term in the predetermined list.

2. The method of claim 1, further comprising:
displaying a list of media files for at least one of the matched text message terms.

3. The method of claim 2, wherein the list of media files is displayed responsive to receiving an indication of a selection of one of the tagged text message terms.

4. The method of claim 2, wherein text messages are displayed in a text message display screen, and wherein the list of media files is displayed simultaneously with and proximate to the text message display screen.

5. The method of claim 2, further comprising:
receiving a selection of the at least one media file in the displayed list;
associating the selected media file with one or more text message terms; and
transmitting the text message with the at least one of the media file associated with the one or more text message terms or a link to the media file associated with the one or more text message terms.

6. The method of claim 2, wherein unidentified terms remain untagged as part of the text message, and the list of media files is displayed after all matches are identified.

7. The method of claim 1, further comprising receiving a selection of the one or more text message terms to compare with the predetermined list of terms.

8. The method of claim 1, wherein a request is sent of each term entered in the text message, or for groups of terms entered in the text message, as the one or more text message terms are entered in the text message on the user device.

9. The method of claim 1, wherein the predetermined list is stored on a remote server, wherein the request is sent to the remote server, and wherein the indication is received from the remote server.

10. The method of claim 1, further comprising transmitting the text message to a message group of user devices sharing a common MMS communication.

11. The method of claim 1, wherein tagging each of the matched one or more text message terms includes accentuating the matched text message terms in a text message display screen of the user device.

12. A method for presentation of media files for integration into a text message comprising:
storing a plurality of text message terms previously selected for media file tagging and a corresponding plurality of media files;
prioritizing a media file of the plurality of media files for association with at least one term of the plurality of text message terms based on a frequency of previous selections of the media file to tag the at least one term of the plurality of text message terms;
receiving a request from a user device to compare an entered text message term to the plurality of text message terms; and
presenting to the user device, at least one prioritized media file suggestion for tagging to the entered message term.

13. The method of claim 12, further comprising determining the at least one term has been previously tagged with a media file on the user device and assigning a highest weight to the media file, such that the media file is presented first in a weighted list of media file suggestions on the user device.

14. The method of claim 13, further comprising incrementing the weight assigned to each media file for each instance the media file is selected for tagging.

15. A system for integrating a media file within a text message comprising:
a content enhancement interface configured to:
receive one or more text message terms generated in a text message on a user device;
send a request to determine whether each of the text message terms matches a term in a predetermined list of media terms, wherein each media term in the predetermined list is associated with at least one media file;
receive an indication of a match between the one or more text message terms and at least one media term in the predetermined list; and
tag each of the matched text message terms with the at least one media file associated with the corresponding matched term in the predetermined list.

16. The system of claim 15, further comprising:
a comprehensive suggestion module configured to display a list of media files corresponding to identified media terms matching the at least one text message term and responsive to receiving an indication of a selection among the list of media files.

17. The system of claim 15, further comprising an audio linking module configured to accentuate at least one of the matched one or more text message terms in the text message upon selection of the media file to associate with the at least one of the matched one or more text message terms.

18. A system for presentation of media files for integration into a text message comprising:
a suggestion module configured to:
store a plurality of text message terms previously selected for media file tagging and a corresponding plurality of media files;
prioritize a media file of the plurality of media files for association with at least one term of the plurality of text message terms based on a frequency of previous selections of the media file to tag the at least one term of the plurality of text message terms;
receive a request from a user device to compare an entered text message term to the plurality of text message terms; and
present to the user device, at least one prioritized media file suggestion for tagging to the selected one or more text message terms.

19. The system of claim 18, wherein the suggestion module retrieves user preferences from a user profile module.

20. The system of claim 18, wherein the suggestion module is further configured to determine the at least one term has been previously tagged with a media file on the user device and assigning a highest priority to the media file, such that the media file is presented first in a list of media file suggestions on the user device.
